(19) United States
(12) Patent Application Publication
(10) Pub. No.: US 2008/0212860 A1
(43) Pub. Date: Sep. 4, 2008

(54) Fast Reconstruction Algorithm for Cone-Beam Ct

(75) Inventor: Hermann Schomberg, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/916,540

(22) PCT Filed: Jun. 2, 2006
(86) PCT No.: PCT/IB06/51780

§ 371 Date: Dec. 5, 2007

(30) Foreign Application Priority Data
Jun. 7, 2005 (EP) 05104916.1

(51) Int. Cl. G06K 9/00

(52) U.S. Cl. 382/131

(57) ABSTRACT

A fast reconstruction algorithm for cone-beam computed tomography is presented. The algorithm is of the filtered backprojection type and uses nonuniform fast Fourier transforms to switch between functions defined and uniformly sampled on the detector plane and the Fourier transforms of these functions, sampled on a polar grid in the associated Fourier plane.

The present invention relates to the field of computed tomography (CT). In particular, the present invention relates to a method of reconstructing a three-dimensional image of an object's volume of interest from a set of cone-beam projections of this object, to an image processing device, to an examination apparatus, to a computer-readable medium, and to a program element.

In cone-beam CT, a set of X-ray cone-beam projections of an object's volume of interest (VOI) is acquired while an X-ray source moves along some source trajectory around the object. Then, a three-dimensional (3D) image of the object's VOI is reconstructed from this set of cone-beam projections. The projections are acquired by means of a cone-beam CT scanner. Such a cone-beam CT scanner is equipped with a point-like X-ray source and a large-area X-ray detector. Typically, the detector is flat and subdivided into a two-dimensional (2D) array of small detector elements. Such a flat detector naturally defines a 2D plane in 3D space, the detector plane, which is rigidly attached to the detector and moves as the detector moves. The cone-beam is formed by those X-rays that emanate from the source and intercept the detector. The 2D array of detector readings obtained when the source is at a fixed position constitutes a raw cone-beam projection. The value read by a detector element represents the intensity of the X-ray beamlet that emanates from the source and intercepts this detector element. In a preprocessing step, the detector readings are converted to line integrals of the X-ray attenuation coefficient within the object, the lines of integration being determined by the positions of the source and the detector element that read the original value. In the following, unless stated otherwise, this preprocessing of the detector readings is understood and the term “cone-beam projection” refers to a 2D array of line integrals along known lines of integration. It is to be noted that the acquired set of cone-beam projections is sampled with respect to the source position along the source trajectory and, for each sampled source position, the associated cone-beam projection is sampled with respect to the positions of the detector elements in the detector plane. Conceptually, the cone-beam projection associated with a designated source position may be viewed as a sampled estimate of a function of two variables that is defined on the detector plane associated with this source position. The image is reconstructed from the set of cone-beam projections by means of an image processing device. The image processing device is a computer that executes a computer program that implements a reconstruction algorithm. The reconstructed image provides a sampled estimate of the 3D map of the X-ray attenuation coefficient within the object's VOI. Such a map can provide valuable information in fields such as medical diagnosis or material testing (in medical applications of cone-beam CT, the object is a patient).

The similarity between the reconstructed map and the true map inside the VOI depends on the satisfaction of various requirements. It is clearly required that the (preprocessed) detector readings be accurate estimates of the wanted line integrals and that the sampling distances between adjacent source positions along the source trajectory and between adjacent detector elements in the detector plane be sufficiently small. Moreover, at least the idealized, non-sampled and error-free, cone-beam projections of the object should determine the true map with good accuracy. It is known that this is the case if the projections are not truncated and if the source trajectory is complete with respect to the volume that contained the object's VOI during the scan.

In this context, a cone-beam projection is said to be truncated, if the object being projected is not fully covered by the projecting cone-beam.

Moreover, a source trajectory is said to be complete with respect to some volume, if each plane that intersects this volume also intersects the source trajectory. In the following, a phrase like “complete with respect to the volume V” will usually be abbreviated by “complete,” and the unspecified volume is to be inferred from the context. It will be noted that a source trajectory that is to be complete with respect to some true volume must be nonplanar. A common source trajectory is a circle. This source trajectory is simple to realize by a rotational movement about a single axis, but it is planar and therefore not complete.

The two mentioned conditions are sufficient to determine the true map, but not strictly necessary. For example, if the source trajectory is a circle, it may still be possible to obtain an acceptable reconstruction in some volume around the center of the circle.

A cone-beam CT scanner may be realized in various ways. For example, the X-ray source and the X-ray detector may be mounted to the ends of a C-arm, which may be moved around the object. By a proper combination of two rotational movements, it is possible to realize complete source trajectories, as described in the U.S. Pat. No. 6,582,120. Source and detector may also be mounted onto a rotating gantry. In this way, one can realize circular source trajectories, but if the gantry is tiltable, complete source trajectories can also be realized. Another type of gantry that is capable of realizing complete source trajectories is disclosed in the U.S. Pat. No. 5,124,914.

C-arm based scanners are normally equipped with a flat detector. Gantry-based scanners may have a flat or a nonflat detector. A flat detector has a natural detector plane associated with it and is usually subdivided into a 2D array of small detector elements. In such a case, each cone-beam projection of the acquired set of cone-beam projections will be sampled on an equidistant Cartesian grid in the detector plane. If the detector is not flat, one can nevertheless associate a virtual detector plane with the detector and pretend that each cone-beam projection is sampled in this virtual detector plane. In such a case, the grid of sampling points will be planar, but in general not equidistant Cartesian.

A cone-beam CT scanner will include an image processing device that reconstructs the image by executing the reconstruction algorithm. It will also include a viewing console for displaying reconstructed images. Finally, it will include means that allow an operator to operate the scanner.

Various reconstruction algorithms have been proposed that are able to reconstruct the desired 3D map of the X-ray attenuation coefficient in the object's VOI, provided the data determine this map sufficiently well.

Many of these reconstruction algorithms have a “continuous version,” found by inverting a mathematical model of the data acquisition process. The model consists of a formula or a set of formulas that accepts or accept the 3D map of the X-ray attenuation of the object as input function and determines or determine an output function that represents the set of cone-beam projections. The continuous version of the reconstruction algorithm inverts this model: Given an input function that represents the set of cone-beam projections, the continuous version consists of a formula or a set of formulas that determines or determine another function that represents the 3D map of the X-ray attenuation coefficient. To implement the reconstruction algorithm on a computer, one needs a discretized version of the continuous version. To devise such a discretized version, one replaces the “continuous” functions by discrete, or sampled, approximations, and the formula or set of formulas by an appropriate numerical algorithm or appropriate numerical algorithms. Finally, the resulting discrete version of the reconstruction algorithm is formulated as a computer program which may be executed by the image processing device of the cone-beam CT scanner. The discrete version of the reconstruction algorithm will introduce “discretization errors” of its own into the reconstructed images. The discretization process involves various sampling grids, the pattern and density of which need to be properly chosen in order to keep the discretization errors small.

It is desirable that the sampling grid for each cone-beam projection be planar and equidistant Cartesian. The planarity comes naturally if the detector is flat, otherwise one can achieve the planarity by introducing a virtual detector plane. Even if the detector is flat, one may introduce a virtual detector plane that is different from the plane that contains the sensitive area of the detector. If a planar grid is not equidistant Cartesian, one can resample the cone-beam projections onto an equidistant Cartesian grid, if so desired. In the following, any such resampling will be regarded as a part of the preprocessing step. Since the resampling process may degrade the accuracy of the acquired cone-beam projections, it may be desirable to avoid the resampling, if possible. In the following, it will be assumed that the sampling grid is planar. The term “detector plane” will mean the virtual detector plane, if such a plane is used. The sampling grid in the detector plane may be equidistant Cartesian or not.

It is always desirable, and for many applications of cone-beam CT mandatory, that the reconstruction algorithm be fast.

One example of a reconstruction algorithm is the cone-beam filtered back-projection algorithm by Defrise and Clack, which is described in M. Defrise and R. Clack, “A cone-beam reconstruction algorithm using shift-variant filtering and cone-beam backprojection,” IEEE Trans. Med. Imag., vol. 13, no. 1, pp. 186-195, 1994, and which is incorporated herein by reference. The Defrise and Clack algorithm has a favorable algorithmic structure: Each projection is “filtered” and “backprojected,” and may be discarded afterwards. The filtering step of the Defrise and Clack algorithm is rather complicated and involves computing forward and backward 2D Radon transforms of various intermediate functions. It is also necessary to take certain partial derivatives of some of these intermediate functions. The backprojection step is a common part of many CT reconstruction algorithms. To the extent possible, the Defrise and Clack algorithm gives reasonable results even if the source trajectory is not complete. Truncated projections can cause disturbing artifacts. However, it is possible to reduce these artifacts substantially by extending the truncated projections prior to the reconstruction so that the extended projections appear roughly like nontruncated projections of an object that is a little bigger than the VOI. Such a method is disclosed in the U.S. Pat. No. 6,542,573.

On the other hand, its complicated filtering step makes the Defrise and Clack algorithm computationally very slow. In principle, it is possible to use so-called Fourier methods to speed up the filtering step. The key is a well known relationship between the Radon transform and the Fourier transform. This relationship is paraphrased by the so-called projection theorem, which states that the row-wise 1D Fourier transform of the 2D Radon transform of a function of two variables equals the 2D Fourier transform of this function along radial lines in 2D Fourier space. The mentioned partial derivatives can also be realized in Fourier space, by virtue of the so-called derivative theorem for the Fourier transform. Also needed are fast computational methods for computing 2D Fourier transforms and their inverses, where either the output or the input functions are not sampled on an equidistant Cartesian grid. Combining these ideas and fast 2D forward and inverse “discrete Fourier transforms” in a proper manner would lead to a “Fourier-filtered” backprojection algorithm.

One such Fourier-filtered backprojection algorithm has been indicated in the dissertation by C. Jacobson, “Fourier methods in 3D reconstruction from cone-beam data,” Linköping University, Sweden, 1996, pp. 112-113. The Jacobson algorithm uses so-called linogram techniques for the required fast 2D forward and inverse discrete Fourier transforms. Linogram techniques are described, for example, in P. R. Edholm, G. T. Herman, and D. A. Roberts, “Inage reconstruction from linograms: Implementation and evaluation,” IEEE Trans. Medical Imaging, vol. 7, pp. 239-246, 1988, and M. Magnusson, Linogram and Other Direct Fourier Methods for Tomographic Reconstruction, Dissertation No. 320, Linköping University, S-58183 Linköping, Sweden, 1993. Linogram techniques necessitate the usage of a special grid in 2D Fourier space, the grid points of which are located on concentric squares. This is because such a grid makes it possible to invoke the so-called chirp z-transform as a relatively fast means to compute the required 2D discrete Fourier transforms. The chirp z-transform is described, for example, in Magnusson's dissertation. Unfortunately, a grid of concentric squares introduces a certain angular and radial anisotropy into the reconstructed image. To reduce the resulting discretization errors, one is forced to choose a relatively high density of the grid points of the concentric squares grid, which increases the number of grid points and, thus, the computation time.

It may be desirable to have a reconstruction algorithm for cone-beam CT that retains the advantages of the Defrise and Clack algorithm and avoids the disadvantage of the Jacobson algorithm.

According to an exemplary embodiment of the present invention, a method of reconstructing a 3D image of an object's VOI from a set of cone-beam projections of the object may be provided, the projections being taken from a plurality of source positions along a source trajectory, the method comprising the steps of filtering the set of projections on the basis of a concentric circles grid in Fourier space, resulting in a filtered projection data set, and reconstructing the volume of interest from the filtered projection data set, resulting in a reconstructed image of the volume of interest.

According to this exemplary embodiment of the invention, a grid in 2D Fourier space is used, the grid points of which are located on concentric circles, rather than squares.

According to another exemplary embodiment of the invention, the required 2D forward and inverse discrete Fourier transforms are realized using so-called nonuniform fast Fourier transforms.

The term “nonuniform fast Fourier transform” (nonuniform FFT) is used here as a generic name for a class of methods that can be used to compute discrete Fourier transforms (represented by trigonometric sums) when the output grid or the input grid or both are not equidistant Cartesian. Depending on the grid types involved, one may distinguish between a uniform-to-nonuniform FFT, a nonuniform-to-uniform FFT, and a nonuniform-to-nonuniform FFT. In all three cases, there is a “forward version” and a “backward” version, depending on whether the Fourier transform or the inverse Fourier transform is to be computed. The nonuniform FFT is described, e.g., in the article by A. Fessler and B. P. Sutton, “Nonuniform fast Fourier transforms using min-max interpolation,” IEEE Trans. Signal Processing, vol. 14, no. 3, pp 560-574, 2003. This article also cites further references to closely related methods, among them the class of “gridding methods.” If both grids involved are equidistant Cartesian, one can use the classical fast Fourier transform, here denoted as uniform-to-uniform FFT.

According to another exemplary embodiment of the present invention, an image processing device for the reconstruction of an object's VOI from a set of projections of cone-beam projections of this object may be provided. The image processing device comprises a calculation unit and a memory for storing data. The calculation unit is adapted for performing a method according to an exemplary embodiment of the present invention.

According to another exemplary embodiment of the present invention, an examination apparatus for reconstructing an image from a set of projections of an object may be provided, the examination apparatus comprising a calculation unit adapted for performing the above-mentioned method steps.

According to another exemplary embodiment of the present invention, the examination apparatus further comprises an electromagnetic radiation source and a large-area detector, the source being adapted for emitting electromagnetic radiation to the object of interest from a set of source positions along a source trajectory, and the detector being placed and adapted such that it measures cone-beam projections of the object's VOI.

Furthermore, according to another exemplary embodiment of the present invention, the examination apparatus is configured as one of the group consisting of a baggage inspection apparatus, a medical diagnostic apparatus, a material testing apparatus and a material science analysis apparatus. A field of application of the invention may be baggage inspection, since the defined functionality of the invention may allow for a secure and reliable and fast analysis of the content of a baggage item allowing to detect suspicious content, even allowing to determine the type of a material inside such a baggage item.

According to another exemplary embodiment of the present invention, a computer-readable medium may be provided, in which a computer program for reconstructing an image from a set of projections of an object of interest with an examination apparatus is stored which, when being executed by a processor, is adapted to carry out the above-mentioned method steps.

The present invention also relates to a program element of reconstructing an image from a projection data set of an object of interest, which, when being executed by a processor, is adapted to carry out the above-mentioned method steps. The program element may preferably be loaded into the working memory of a data processor. The data processor may thus be equipped to carry out exemplary embodiments of the methods of the present invention. The computer program may be written in any suitable programming language, such as, for example, Cow and may be stored on a computer-readable medium, such as a CD-ROM. Also, the computer program may be available from a network, such as the WorldWideWeb, from which it may be downloaded into image processing devices or processors, or any suitable computers.

These and other aspects of the present invention will become apparent from and elucidated with reference to the embodiments described hereinafter.

Exemplary embodiments of the present invention will be described in the following, with reference to the following drawings.

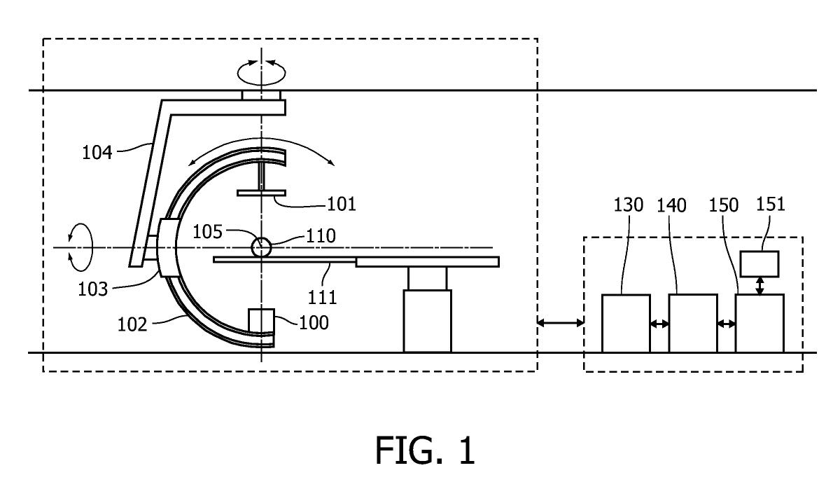

FIG. 1 shows a schematic drawing of an exemplary cone-beam CT scanner.

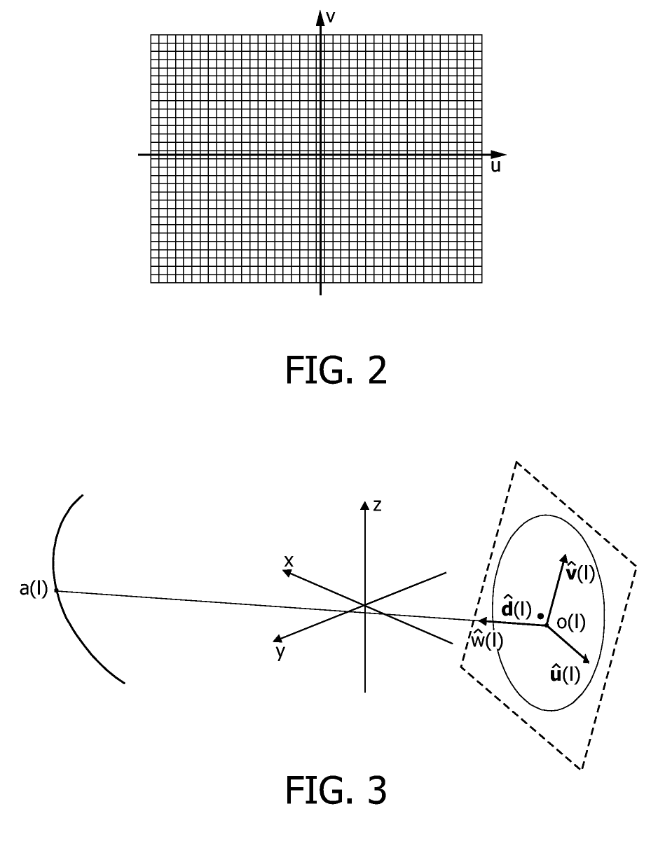

FIG. 2 shows an exemplary detector geometry.

FIG. 3 shows an exemplary cone-beam acquisition geometry.

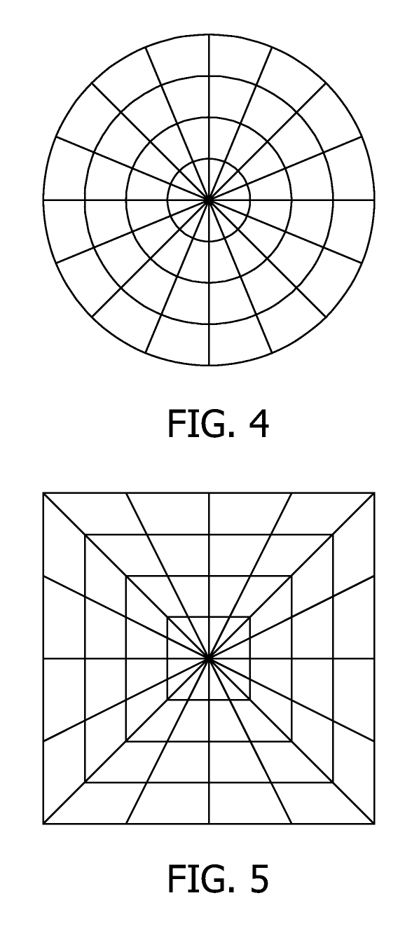

FIG. 4 shows an exemplary grid of concentric circles.

FIG. 5 shows an exemplary grid of concentric squares.

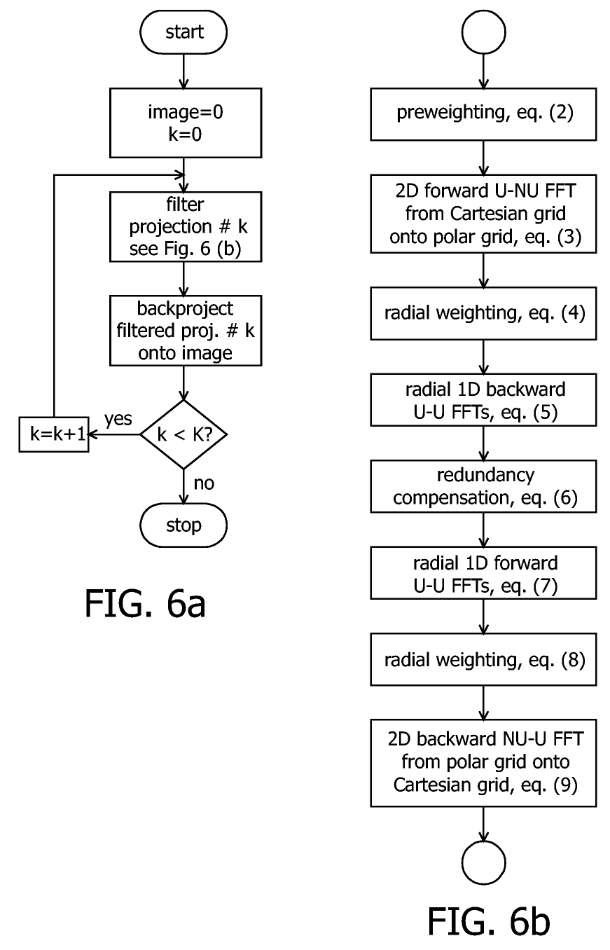

FIG. 6 shows a program flow chart of an exemplary embodiment of the reconstruction algorithm of the invention.

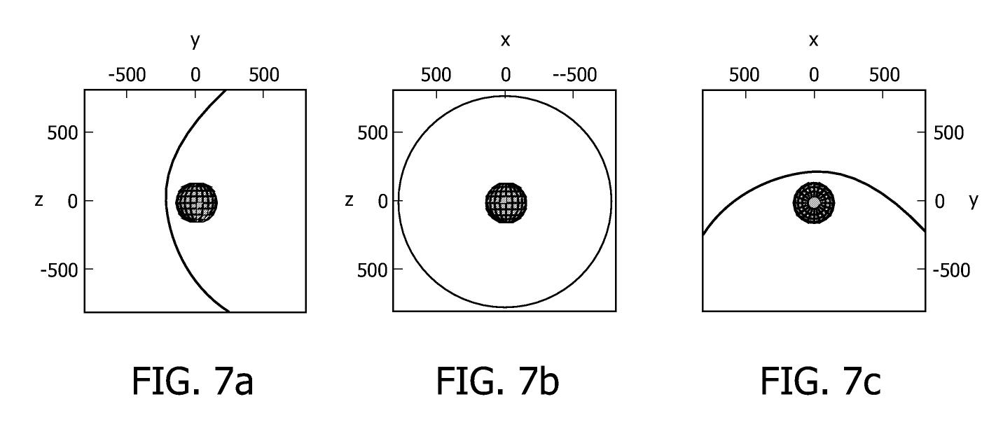

FIG. 7 shows an exemplary complete source trajectory.

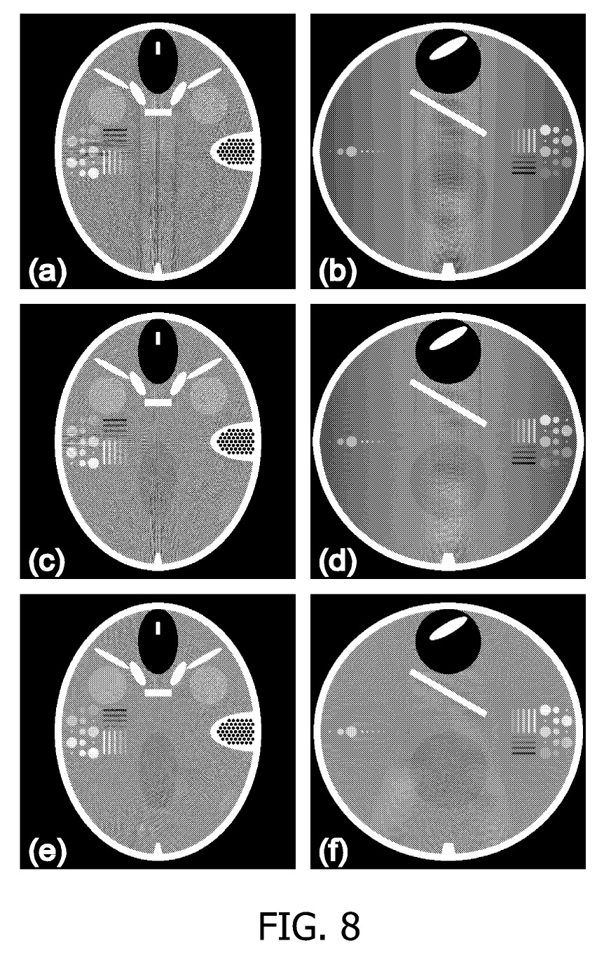

FIG. 8 shows 2D cross-sections of 3D images that were reconstructed from simulated cone-beam projections.

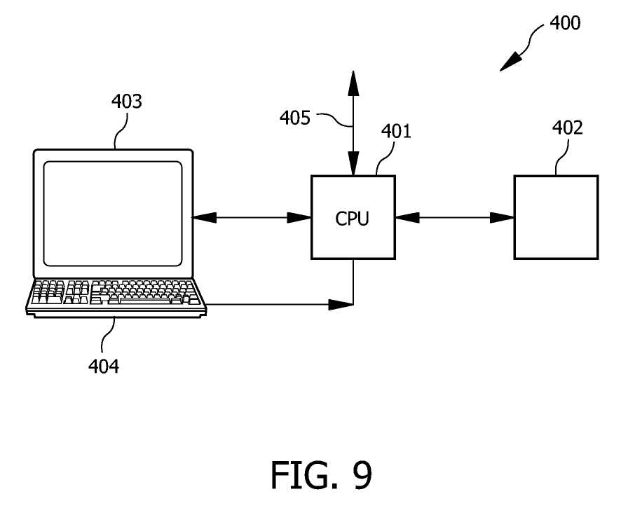

FIG. 9 shows an exemplary embodiment of an image processing device according to the present invention, for executing an exemplary embodiment of a method in accordance with the present invention.

### CONE-BEAM CT SCANNER

A schematic drawing of an exemplary cone-beam CT scanner is shown in FIG. 1. An X-ray source 100 and a flat detector 101 with a large sensitive area are mounted to the ends of a C-arm 102. The C-arm 102 is held by curved rail, the “sleeve” 103. The C-arm can slide in the sleeve 103, thereby performing a “roll movement” about the axis of the C-arm. The sleeve 103 is attached to an L-arm 104 via a rotational joint and can perform a “propeller movement” about the axis of this joint. The L-arm 104 is attached to the ceiling via another rotational joint and can perform a rotation about the axis of this joint. The various rotational movements are effected by servo motors. The axes of the three rotational movements and the cone-beam axis always meet in a single fixed point, the “isocenter” 105 of the cone-beam CT scanner. There is a certain volume around the isocenter that is projected by all cone beams along the source trajectory. The shape and size of this “volume of projection” (VOP) depend on the shape and size of the detector and on the source trajectory. In FIG. 1, the ball 110 indicates the biggest isocentric ball that fits into the VOP. The object (e.g. a patient or an item of baggage) to be imaged is placed on the table 111 such that the object's VOI fills the VOP. If the object is small enough, it will fit completely into the VOP; otherwise, not. The VOP therefore limits the size of the VOI.

The various rotational movements are controlled by a control unit 120. Each triple of C-arm angle, sleeve angle, and L-arm angle defines a position of the X-ray source. By varying these angles with time, the source can be made to move along a prescribed source trajectory. The detector at the other end of the C-arm makes a corresponding movement. The source trajectory will be confined to the surface of an isocentric sphere.

FIG. 2 illustrates the sensitive area of the detector 101. The sensitive area is a rectangle and subdivided into a 2D array of equal-sized detector elements. The output of the detector 102 is a corresponding array of data elements. The array of data associated with a certain source position constitutes a raw cone-beam projection. A set of raw cone-beam projections is acquired while the source moves along a prescribed source trajectory. The source positions associated with these raw cone-beam projections are known. The raw cone-beam projections are transferred to the preprocessing device 130, where they are preprocessed. The preprocessed cone-beam projections are then fed into the image processing device 140, which is a computer that executes a computer program that implements the reconstruction algorithm. If the projections are truncated and to be extended prior to the reconstruction, the image processing device 140 also performs the extension of the projections. The reconstructed image is displayed on the monitor 151 of the console 150. The console 151 is also used to control the cone-beam CT scanner and presents a user interface to the operator.

The cone-beam CT scanner is complemented by further ancillary equipment, such as a high voltage generator for the X-ray tube, cooling means for the X-ray tube, and electrical cables. Such ancillary equipment is not shown in the figure.

Mathematical Transforms

The detailed description of an exemplary embodiment of the invention makes use of several well known mathematical transforms. These transforms are defined in this subsection. Some well known properties of these transforms are also stated.

The Fourier transform of a function g: R^{d}→C is defined by

$$( {F}_{d} g ) ( y ) = {\int }_{{R}^{d}} g ( x ) exp ( - i 2 π x \cdot y ) d x .$$

The Hilbert transform of a function h: R→C is defined by (F₁H₁h)(σ)=isign(σ)(F₁h)(σ). The derivative operator D₁ is defined by (F₁D₁h)(σ)=i2πσ(F₁h)(σ). By convention, if F₁, F₁⁻¹, H₁, or D₁ are applied to functions of more than one variable, they act on the first variable. The Radon transform of a function g: R²→C is defined by

$$( {R}_{2} g ) ( s , θ ) = {\int }_{R} g ( s cos θ - t sin θ , s sin θ + t cos θ ) d t .$$

The backprojection of a function g: R×[0, π]→R is defined by

$$( {B}_{2} h ) ( u , v ) = {\int }_{0}^{π} h ( u cos θ + v sin θ , θ ) d θ .$$

The inversion formula 2πR₂⁻¹=−B₂D₁H₁ yields the identity 2πR₂⁻¹H₁=B₂D₁. The projection theorem for R₂ states that (F₁R₂g)(σ, θ)=(F₂g)(σ cos θ, σ sin θ). The shift theorem for R₂ states that (R₂g_{a,b})(s, θ)=(R₂g)(s−a cos θ−b sin θ, θ) where g_{a,b}(u, v)=g(u−a, v−b). By convention, if F₂, F₂⁻¹, R₂, R₂⁻¹, or B₂ are applied to functions of more than two variables, they act on the first two variables.

Fast Uniform and Nonuniform Discrete Fourier Transforms

This subsection provides background information about discrete Fourier transforms and nonuniform fast Fourier transforms.

Let {xₖεR^{d}: kεK} and {yⱼεR^{d}: jεJ} be two arbitrary finite grids in R^{d}. Suppose we are given the samples g(xₖ), kεK, of some function g: R^{d}→C and wish to compute the samples ĝ(yⱼ), jεJ, of the function ĝ=F_{d}g. A general approach for solving this problem is to approximate

$$\hat{g} ( y ) = {\int }_{{R}^{d}} g ( x ) exp ( - i 2 π x \cdot y ) d x$$

by the trigonometric sum ĝ*(y)=Σ_{kεK}cₖg(xₖ)exp(−i2πxₖ·y) with suitable quadrature coefficients cₖ and to take ĝ* as an approximation to ĝ. Note that ĝ*=\hat{p}*ĝ with the point-spread function (PSF) \hat{p}(y)=Σ_{kεK}cₖg(xₖ)exp(−i2πxₖ·y). The samples ĝ*(yⱼ), jεJ, constitute a discrete Fourier transform (DFT) of the samples g(xₖ), kεK. The reverse problem of computing the samples g(xₖ), kεK, from the samples ĝ(yⱼ), jεJ, may be solved by approximating g by a trigonometric sum of the form g*(x)=Σ_{jεJ}ĉⱼĝ(yⱼ)exp(i2πx·yⱼ) and computing the samples g*(xₖ), kεK, which constitute an inverse DFT of the samples ĝ(yⱼ), jεJ. Note that g*=p*g with the PSF p(x)=Σ_{jεJ}ĉₖĝ(yⱼ)exp(i2πx·yⱼ). If the input grid of the (inverse) DFT is an equidistant Cartesian grid and if the output grid is not such a grid, we speak of a uniform-to-nonuniform (U-NU) DFT. In a similar fashion, we refer to the remaining cases as the NU-U DFT, the NU-NU DFT, and the U-U DFT. In all four cases, we can go forward (compute F_{d}g) or backward (compute F_{d}⁻¹ĝ). If the input grid is an equidistant Cartesian grid of the form {ka: −K/2≦k<K/2} with aεR₊^{d} and KεZ₊^{d} and if the output grid is the conjugate grid {nb: −K/2≦n<K/2} with b=1/(Ka), then the U-U DFT is essentially the classical DFT (Expressions like ka and 1/(Ka) are understood componentwise). Moreover, under modest constraints on K, the U-U DFT can be computed very efficiently using the classical fast Fourier transform (FFT), here called the U-U FFT. Fast algorithms for computing the NU-U DFT and the U-NU DFT, here called the NU-U FFT and the U-NU FFT, have become available more recently. These algorithms may also be used to assemble an NU-NU FFT.

For example, a forward NU-NU FFT is obtained by concatenating a forward NU-U FFT, a backward U-U FFT, and a forward U-NU FFT. The term nonuniform FFT is used generically for the U-NU FFT, the NU-U FFT, and the NU-NU FFT. To distinguish the Fourier transform from the discrete Fourier transform, we sometimes refer to the former as the “continuous Fourier transform.”

With all the above uniform and nonuniform FFTs, if the input data or the output data are real, it is possible to nearly halve the computation time.

The Reconstruction Problem

The source trajectory should consist of a finite number of smooth segments. For simplicity, we assume that it consists of a single segment only.

We attach a right-handed Cartesian x-y-z coordinate system to the object table, thereby establishing a correspondence between points in physical space and points in R³. We refer to this coordinate system as the fixed coordinate system. The source trajectory is represented by a smooth mapping a: Λ→R³, where Λ=[λₘᵢₙ, λₘₐₓ] ⊂R is an interval. Cone-beam projections are taken when the source is at positions a(λₖ), 0≦k<K, with λₘᵢₙ≦λ₀< . . . <λ_{K-1}≦λₘₐₓ.

The sensitive area of the detector is a rectangle of width W and the height H. The array of detector elements has I columns and J rows. For simplicity, we assume that both I and J are even (If necessary, one can make I or J even by adding a dummy row or column).

The sensitive area of the detector belongs to a 2D plane in 3D space, the detector plane, which moves as the detector moves (More generally, a virtual detector plane is admitted). We attach a right-handed Cartesian u-v-w coordinate system to the detector such that the u- and v-axes are parallel to the rows and columns formed by the detector elements and the w-axis points into the half-space in front of the detector. The origin of this detector coordinate system is chosen such that the center points of the detector elements obtain the coordinates (uᵢ, vⱼ, 0)=(iΔu, jΔv, 0), −I/2≦i<I/2, −J/2≦j<J/2, where (Δu, Δv)=(W/I, H/J) is the size of the detector elements. (A similar index range, such as −I/2<i≦I/2, −J/2<j≦J/2, is also fine.) This choice of the origin is illustrated in FIG. 2. The u- and v-coordinates of the points of the sensitive area make up a rectangle D₀⊂R². More generally, this set could depend on λ, and we write D₀(λ) instead of D₀.

In the fixed coordinate system, the trajectory of the origin of the detector coordinate system is represented by a mapping d: Λ→R³. The orientation of the u- and v-axes is represented by two further mappings û, \hat{v}: Λ→{rεR³: ∥r∥₂=1}. The mappings a, d, û, \hat{v} and the set D₀ define the acquisition geometry. The acquisition geometry is illustrated in FIG. 3 and assumed to be known. The detector plane associated with a source point a(λ) is given by Δ(λ)={d(λ)+uû(λ)+v\hat{v}(λ): (u, v)εR²}. Every pεΔ(λ) can be written in the form p=d(λ)+uû(λ)+v\hat{v}(λ) with d(λ)-centered detector coordinates (u, v). For each λεΛ, we let c(λ)εR³ be the orthogonal projection of a(λ) onto Δ(λ). Every pεΔ(λ) can also be written in the form p=c(λ)+ũû(λ)+\tilde{v}\hat{v}(λ) with c(λ)-centered detector coordinates (ũ, \tilde{v}) The d(λ)-centered detector coordinates of c(λ) are computable from the acquisition geometry and denoted by (u_{c}(λ), v_{c}(λ)).

The X-ray attenuation coefficient of the object is represented by a function ƒ: R³→R, unknown as yet. The (ideal) cone-beam projections of the object are represented by the function

$${g}_{all} ( u , v , λ ) = {\int }_{0}^{∞} f ( a ( λ ) + t \hat{α} ( u , v , λ ) ) d t , \qquad ( 1 )$$

where â(u, v, λ) is the unit vector that points from a(λ) to d(λ)+uû(λ)+v\hat{v}(λ)εΔ(λ). Note that the first two variables of g are d(λ)-centered detector coordinates. We denote the restriction of gₐₗₗ to the “measured” domain {(u, v, λ): λεΛ, (u, v)εD₀(λ)} by gₘ. Moreover, we let g: R²×Λ→R be a function that agrees with gₘ in the domain {(u, v, λ): λεΛ, (u, v)εD₀(λ)} and estimates gₐₗₗ outside this domain. For example, g could be obtained by extending the measured data gₘ using the method described in the U.S. Pat. No. 6,542,573. Note that g=gₐₗₗ=gₘ in the measured domain {(u, v, λ): λεΛ, (u, v)εD₀(λ)}. The (ideal) projections are said to be truncated if gₐₗₗ(u, v, λ)≠0 for some λεΛ and (u, v)εR²\D₀(λ). The data acquisition process and the subsequent preprocessing of the acquired raw data provide (estimates of) the samples g(uᵢ, vⱼ, λₖ), −I/2≦i<I/2, −J/2≦j<J/2, 0≦k<K. Using this sampled version of g and our knowledge of the acquisition geometry and of the sampling points (uᵢ, vⱼ, λₖ), we wish to reconstruct f in some subset V of the VOP.

The Reconstruction Algorithm

If the source trajectory is complete with respect to V and if the projections are not truncated, then f can be reconstructed in V by one of the known exact cone-beam reconstruction algorithms, up to the errors caused by the errors in the data, the sampled nature of the data, and the errors introduced by the reconstruction algorithm. One candidate reconstruction algorithm is the cone-beam filtered backprojection algorithm of Defrise and Clack, here referred to as CBFBP. Unfortunately, the filtering step of CBFBP is computationally very slow. Below, we present a modified version of CBFBP which overcomes this drawback. This is achieved by reformulating the filtering step so that it may be implemented using uniform and nonuniform FFTs. We refer to this cone-beam Fourier-filtered backprojection algorithm as CBFFBP.

Like the original version, the modified version involves a redundancy compensation function (RCF). The RCF is defined on the set of planes that contain a source point and intersect the detector plane associated with that source point. Let P be such a plane, and let a(λ) be a source point in it. The intersection of P with Δ(λ) is a line, and exactly one point of this line is closest to c(λ). This closest point may be written in the form c(λ)+\tilde{s} cos \tilde{μ}û(λ)+\tilde{s} sin \tilde{μ}\hat{v}(λ) with c(λ)-centered polar detector coordinates (\tilde{s}, \tilde{μ}). In this way, the RCF becomes a function \tilde{M} of the parameter triple (\tilde{s}, \tilde{μ}, λ). The RCF must satisfy a certain normalization condition, but is not uniquely determined by the source trajectory. A suitable RCF was proposed in the cited article of Defrise and Clack. This RCF may be precomputed using the method described in F. Noo, M. Defrise, and R. Clack, “Direct reconstruction of cone-beam data acquired with a vertex path containing a circle,” IEEE Trans. Image Processing, vol. 40, no. 4, pp. 1092-1101, August 1998. Unlike the original version, which works with the c(λ)-centered data \tilde{g}(ũ, \tilde{v}, λ)=g(ũ+u_{c}(λ), \tilde{v}+v_{c}(λ), λ), the modified version works with the d(λ)-centered data g(u, v, λ). The algorithm also involves the derivative a′(λ) of the source trajectory, the distance w(λ)=∥a(λ)−c(λ)∥ between source and detector, and the vector Ω(s, μ, λ)=w(λ)cos μû(λ)+w(λ)sin μ\hat{v}(λ)+sŵ(λ), where ŵ(λ)=û(λ)×\hat{v}(λ). Here is the continuous version of CBFFBP:

1. Filtering: For each λεΛ, compute the functions

$$\begin{matrix}{g}_{1} ( u , v , λ ) = \frac{w ( λ )}{\sqrt{{( u - {u}_{c} ( λ ) )}^{2} + {( v - {v}_{c} ( λ ) )}^{2} + {w ( λ )}^{2}}} g ( u , v , λ ) , & ( 2 ) \\ {\hat{g}}_{2} ( ξ , η , λ ) = ( {F}_{2} {g}_{1} ) ( ξ , η , λ ) , & ( 3 a ) \\ {\hat{h}}_{2} ( σ , μ , λ ) = {\hat{g}}_{2} ( σ cos μ , σ sin μ , λ ) , & ( 3 b ) \\ {\hat{h}}_{3} ( σ , μ , λ ) = i 2 π σ {\hat{h}}_{2} ( σ , μ , λ ) , & ( 4 ) \\ {h}_{3} ( s , μ , λ ) = ( {F}_{1}^{- 1} {\hat{h}}_{3} ) ( s , μ , λ ) , & ( 5 ) \\ \begin{matrix}{h}_{4} ( s , μ , λ ) = - \frac{\vert {a}^{′} ( λ ) \cdot Ω ( \tilde{s} ( λ ) , μ , λ ) \vert}{4 {π}^{2} {w ( λ )}^{2}} \tilde{M} ( \tilde{s} ( λ ) , μ , λ ) {h}_{3} ( s , μ , λ ) , \\ \tilde{s} ( λ ) = s - {u}_{c} ( λ ) cos μ - {v}_{c} ( λ ) sin μ\end{matrix} & ( 6 ) \\ {\hat{h}}_{4} ( σ , μ , λ ) = ( {F}_{1} {h}_{4} ) ( σ , μ , λ ) , & ( 7 ) \\ {\hat{h}}_{5} ( σ , μ , λ ) = i 2 π sign ( σ ) {\hat{h}}_{4} ( σ , μ , λ ) , & ( 8 ) \\ {\hat{g}}_{5} ( σ cos μ , σ sin μ , λ ) = {\hat{h}}_{5} ( σ , μ , λ ) , & ( 9 a ) \\ {g}_{6} ( u , v , λ ) = ( {F}_{2}^{- 1} {\hat{g}}_{5} ) ( u , v , λ ) . & ( 9 b )\end{matrix}$$

2. Backprojection: Compute

$${f}_{rec} ( r ) = {\int }_{Λ} \frac{{( u ( r , λ ) - {u}_{c} ( λ ) )}^{2} + {( v ( r , λ ) - {v}_{c} ( λ ) )}^{2} + {w ( λ )}^{2}}{{‖ r - a ( λ ) ‖}^{2}} {g}_{6} ( u ( r , λ ) , v ( r , λ ) , λ ) d λ , r ∈ V , \qquad ( 10 )$$

where u(r, λ) and v(r, λ) are the d(λ)-centered detector coordinates of the perspective projection of r from a(λ) onto Δ(λ).

It is easy to see that the continuous versions of CBFFBP and CBFBP are equivalent: Using the projection theorem for R₂ and the Fourier representation of D₁, one finds that (3a)-(5) are equivalent to

h₂=R₂g₁,

h₃=D₁h₂. (11)

Using the Fourier representation of H₁ and the projection theorem for R₂, one further finds that (7)-(9b) are equivalent:

h₅=2πH₁h₄,

g₆=R₂⁻¹h₅. (12)

Substituting (11) for (3a)-(5) and (12) for (7)-(9b) thus leads to an equivalent algorithm, denoted here by CBFBP2. Using the identity 2πR₂⁻¹H₁=B₂D₁ and the shift theorem for R₂, it is finally straightforward to verify that CBFBP2 is equivalent to the original version, CBFBP. Actually, the equivalence of these three algorithms is independent of the origin and the orientation of the detector coordinate system, as long as its u- and v-axes lie in the detector plane.

For the numerical implementation of the filtering step of CBFFBP, we need to decide on appropriate sampling grids for the various functions involved. The input data and all intermediate functions depend on λ as the third variable. For this variable we take the grid {λₖ: 0≦k<K}. The first two variables depend on the function at hand. For the functions g, g₁, and g₆, we take the grid {(uᵢvⱼ): −I/2≦i<I/2, −J/2≦j<J/2} introduced in the subsection The Reconstruction Problem. The d(λ)-centered data, g, are directly available on this grid. (The c(λ)-centered data, \tilde{g}, are generally not.) For the functions h₃ and h₄, we take a standard “sinogram” grid of the form {(sₘ, θ)=(mΔₛ, nΔθ): −N_{rad}/2≦m<N_{rad}/2, 0≦n<N_{ang}} with N_{rad}Δs≧\sqrt{W²+H²} and N_{ang}Δθ=π for some N_{ang} between, say, N_{rad} and 3N_{rad}/2. For the functions ĥ₂, ĥ₃, ĥ₄, and ĥ₅ we use the conjugate grid {(σ_{μ}, θₙ): −N_{rad}/2≦μ<N_{rad}/2, 0≦n<N_{ang}} where σ_{μ}=μΔσ, Δσ=1/(N_{rad}Δs). For the functions ĝ₂ and ĝ₅, we use the associated polar grid {(σ_{μ} cos θₙ, σ_{μ} sin θₙ): −N_{rad}/2≦μ≦N_{rad}/2, 0≦n<N_{ang}}. An example of such a polar grid is shown in FIG. 4. The grid points are located at the intersections of radial lines and concentric circles.

The filtering step is carried out for each λₖ, 0≦k<K. The numerical implementation of the substeps (2), (4), (6), and (8) is straightforward. For the remaining substeps we employ fast uniform and nonuniform DFTs. Specifically, to compute ĥ₂ from g₁ via (3a) and (3b), we use the 2-D forward U-NU DFT/FFT with constant quadrature coefficients cᵢⱼ=ΔuΔv. To compute g₆ from ĥ₅ via (9a) and (9b), we use the 2D backward NU-U DFT/FFT with quadrature coefficients ĉ_{μn}=μΔσΔθ for μ>0 and ĉ₀ₙ=ΔσΔθ/4. The special detector coordinate system chosen in the subsection The Reconstruction Problem allows for particularly efficient implementations. For substeps (5) and (7) we use multiple 1D backward and forward U-U DFTs/FFTs with constant quadrature coefficients Δσ and Δs, respectively. If the sampling grids associated with the various DFTs are sufficiently fine, the resulting PSFs will be well-behaved and cause only small aliasing and truncation errors. With all these FFTs, either the input or the output data may be real, which allows for a reduction of the computational burden by nearly one half.

Instead of a sinogram grid for the functions h₃ and h₄, one might be tempted to use a “linogram” grid and the corresponding conjugate grid for the functions ĥ₂, ĥ₃, ĥ₄, and ĥ₅. (See the cited article of Edholm et al. or the cited dissertation of Magnusson for the notion of a “linogram.”) The functions ĝ₂ and ĝ₅ would then be sampled on concentric squares rather than on concentric circles. Such a concentric squares grid is illustrated in FIG. 5. The quadrature coefficients for the forward U-NU DFT would not change. The quadrature coefficients for the backward NU-U DFT would have to be modified, but suitable coefficients could be found. However, in order to make the PSF for the backward NU-U DFT sufficiently well-behaved, it would be necessary to adjust the parameters of the concentric squares grid so that the density of its grid points along the diagonals of the squares were as high as the radial density of the grid points in the concentric circles case. This would increase the total number of grid points of the concentric squares grid and thus the computational burden of the associated nonuniform FFTs. Alternatively, one might compute the same nonuniform DFTs in the traditional linogram fashion using the chirp z-transform. However, an operation count reveals that these algorithms are not faster than their nonuniform FFT counterparts.

The second step of CBFFBP is a standard cone-beam backprojection. The integral

$${\int }_{Λ} … d λ$$

is approximated by a sum of the form

$${\sum }_{k = 0}^{K - 1} … Δ {λ}_{k} .$$

Clearly, each projection can be backprojected immediately after it has been filtered.

FIG. 6 shows a flow chart of the resulting discrete version of CBFFBP.

If the projections are truncated, it is advisable to extend them prior to the reconstruction, preferrably by using the method disclosed in the U.S. Pat. No. 6,542,573.

It is well known that if the source trajectory is a circle, the continuous version of CBFBP reduces to the continuous version of the FDK algorithm. The FDK algorithm is the standard cone-beam CT reconstruction algorithm for circular source trajectories and is described in L. A. Feldkamp, L. C. Davis, and W. J. Kress, “Practical cone-beam algorithm,” J. Opt. Soc. Amer. A, vol. 1, no. 6, pp. 612-619, 1984. Since the continuous versions of CBFFBP and CBFBP are equivalent, the corresponding statements holds true for CBFFBP.

Demonstration

Algorithm CBFFBP was implemented in the “C” programming language on a personal computer and tested with simulated data. A comparison with a comparable implementation of the FDK algorithm was also made.

Two source trajectories were tried. One of these was the “twisted circle” a_{tc}: [0,2π]→R³ defined by a_{tc}(λ)=r_{src}((cos θ(λ))sin λ, (sin θ(λ))sin λ, (cos θ(λ))cos λ), where r_{src}=810 mm and θ(λ)=α cos 2λ with α=15π/180. FIGS. 7 (a), (b), and (c) illustrate this source trajectory as seen along the x-axis, the y-axis, and the z-axis, respectively. The small ball depicted in these figures has a diameter of 25 cm and indicates the biggest isocentric ball inside the VOP. A twisted circle can be realized by the exemplary cone-beam CT scanner depicted in FIG. 1 by combining a constant speed propeller movement with a sinusoidal roll movement (The propeller joint must support an unrestricted angular range). The other source trajectory was the ordinary circle a_{c}(λ)=r_{src}(sin λ, 0, cos λ), obtained from a_{tc} by setting α=0.

The simulated detector had a square sensitive area of width and height W=H=380 mm and was subdivided into I×J=512×512 detector elements of size (Δu, Δv)=(W/I, H/J). The detector coordinate system was chosen as described in the subsection The Reconstruction Problem. The vector û(λ) was parallel to the plane y=0 for all λε[0,2π]. The d(λ)-centered detector coordinates of c(λ) were u_{C}(λ)=−Δu/2 and v_{C}(λ)=−Δv/2. The distance between source and detector was w(λ)=1195 mm.

The simulated subject was a modified FORBILD head phantom, placed at the origin of the fixed coordinate system so that the plane y=0 became the transversal plane of the phantom and the plane x=0 the sagittal plane. The specification of the FORBILD head phantom is available at the internet site http://www.imp.unierlangen.de/forbild/deutsch/results/head/head.html. The phantom just fits into the small ball indicated in FIG. 7, and its cone-beam projections are not truncated. A simulation program was used to compute K=801 cone-beam projections of the phantom, spaced equidistantly with respect to B.

Images were reconstructed in a centered cubic volume of 512³ cubic voxels, each of size (0.5 mm)³. Portions of the reconstructed image outside the VOP were set to zero. Algorithm CBFFBP was used with both source trajectories, the FDK algorithm with the circle only.

FIGS. 8 (a)-(f) show reconstructed slices images of the modified FORBILD head phantom. FIGS. 8 (a), (c), and (e) show transversal slices, while FIGS. 8 (b), (d), and (f) show sagittal slices. FIGS. 8 (a) and (b) show the slices obtained with FDK in the case of the circle. FIGS. 8 (c) and (d) show the corresponding slices obtained with CBFFBP. FIGS. 8 (e) and (f) show reconstructed slices obtained with CBFFBP in the case of a twisted circle. In all cases, the grey scale window corresponds to the range [0 HU, 100 HU].

In the case of the circle, the images reconstructed by CBFFBP and FDK are roughly comparable. This is not surprising, since the continuous versions of the two algorithms are equivalent then. In those regions of the sagittal slices that are off the plane that contains the source trajectory, one can also see a slight intensity drop and some geometric distortion. These artifacts are well known and a result of the lacking completeness of the circular source trajectory. In the case of the twisted circle, the transversal slice produced by CBFFBP compares favorably with the ones produced by either CBFFBP or FDK in the case of a circle. Owing to the completeness of the twisted circle, however, the sagittal slice produced by CBFFBP is free of the artifacts exhibited by the sagittal slices produced by CBFFBP or FDK in the case of a circle. In the above examples, the filtering step of CBFFBP was 6.9 times slower than that of a comparable implementation of the FDK algorithm and about 70 times faster than that of a comparable implementation of CBFBP2. With both CBFFBP and FDK, the computation time required for the backprojection step exceeded by far the computation time required for the filtering step.

In the previously described exemplary embodiment of the invention, discrete Fourier transforms (trigonometric sums) were used to approximate continuous Fourier transforms, and uniform or nonuniform FFTs were used to compute these discrete Fourier transforms. In principle, other methods for approximating and computing continuous Fourier transforms could also be used. The invention is characterized by the usage of a concentric circles grid in 2D Fourier space. It is recommended that this concentric circles grid be chosen equidistant in both angle and radius, but this is not required.

In the previously described exemplary embodiment, the cone-beam projections were sampled on an equidistant Cartesian grid and the forward U-NU FFT was used to compute ĝ₂(ξ, η, λ) on a concentric circles grid in 2D Fourier space. If the projections are not sampled on an equidistant Cartesian grid, one may resample them onto such a grid, or one may use a forward NU-NU FFT instead of the forward U-NU FFT.

FIG. 9 depicts an exemplary embodiment of an image processing device according to the present invention for executing an exemplary embodiment of the method in accordance with the present invention. The image processing device 400 depicted in FIG. 6 comprises a central processing unit (CPU) or data processor 401 connected to a memory 402 for storing data The data processor 401 may be connected to a plurality of input/output networks or diagnostic devices, such as a CT device. The data processor 401 is connected to a display device 403, for example, a computer monitor, for displaying information or an image computed or processed in the data processor 401. An operator or user may interact with the data processor 401 via a keyboard 404 and/or other output devices, which are not depicted in FIG. 6. Furthermore, via the bus system 405, it is possible to connect the data processor 401 to, for example, a motion monitor, which monitors a motion of the object of interest. For example, if the lung of a patient is to be imaged, the motion sensor may be an exhalation sensor. Or, if the heart is to be imaged, the motion sensor may be an ECG machine.

It should be noted that the term “comprising” does not exclude other elements or steps and the “a” or “an” does not exclude a plurality and that a single processor or system may fulfill the functions of several means or units recited in the claims.

It should be noted, that any reference signs in the claims shall not be construed as limiting the scope of the claims.

1. A method of reconstructing a 3D image of an object's volume of interest from a set of cone-beam projections of the object, the cone beam projections being taken at a plurality of source positions along a source trajectory around the object, the method comprising the steps of:
filtering the set of projections on the basis of a concentric circles grid in Fourier space, resulting in a filtered projection data set; and
reconstructing the volume of interest from the filtered projection data set, resulting in a reconstructed image of the volume of interest.

2. The method of claim 1, wherein the reconstruction of the volume of interest comprises a backprojection of the filtered projection data set according to a discrete approximation to the formula
$${f}_{rec} ( r ) = {\int }_{Λ} \frac{{( u ( r , λ ) - {u}_{c} ( λ ) )}^{2} + {( v ( r , λ ) - {v}_{c} ( λ ) )}^{2} + {w ( λ )}^{2}}{{‖ r - a ( λ ) ‖}^{2}} {g}_{6} ( u ( r , λ ) , v ( r , λ ) , λ ) d λ , r ∈ V ,$$
wherein
r is a position vector with respect to a Cartesian fixed coordinate system,
f_{rec}(r) is the reconstructed image at position r,
V is the volume of interest,
Λ is a bounded interval,
a: Λ→R³ is the source trajectory,
w(λ) is the distance between the source point a(λ) and the detector plane Δ(λ) associated with this source point,
(u(r, λ), v(r, λ)) are coordinates of the perspective projection of r from a(λ) onto the detector plane Δ(λ) with respect to some Cartesian detector coordinate system in the detector plane Δ(λ),
(u_{c}(λ), v_{c}(λ)) are the detector coordinates of the orthogonal projection of a(λ) onto the detector plane Δ(λ), and
g₆ (u, V, λ) are filtered cone-beam projections, obtained by executing discrete versions of the following steps, wherein g(u, v, λ) is a function that equals the acquired cone-beam projections gₘ(u, v, λ) for (u, v)εD₀(λ), the set of detector coordinates of the sensitive detector area when the source is at position a(λ):
(a) Computing,
$${g}_{1} ( u , v , λ ) = \frac{w ( λ )}{\sqrt{{( u - {u}_{c} ( λ ) )}^{2} + {( v - {v}_{c} ( λ ) )}^{2} + {w ( λ )}^{2}}} g ( u , v , λ )$$
on a grid in the u-v plane,
(b) Computing
ĝ₂(ξ,η,λ)=(F₂g₁)(ι,η,λ)
on a polar grid in the ξ-η plane, the grid points of said polar grid being located at the intersections of radial lines and concentric circles,
(c) Defining ĥ₂(σ, μ, λ) in the σ-μ plane by
ĥ₂(σ,μ,λ)=ĝ₂(σ cos μ,σ sin μ,λ),
(d) Computing
ĥ₃(σ,μ,λ)=i2πσĥ₂(σ,μ,λ),
on a grid in the σ-μ plane,
(e) Computing
h₃(s,μ,λ)=(F₁⁻¹ĥ₃)(s,μ,λ),
on a grid in the s-μ plane,
(f) Computing
$${h}_{4} ( s , μ , λ ) = - \frac{\vert {a}^{′} ( λ ) \cdot Ω ( \tilde{s} ( λ ) , μ , λ ) \vert}{4 {π}^{2} {w ( λ )}^{2}} \tilde{M} ( \tilde{s} ( λ ) , μ , λ ) {h}_{3} ( s , μ , λ )$$
on a grid in the s-μ plane, where \tilde{s}(λ)=s−u_{c}(λ)cos μ−v_{c}(λ)sin μ,
(g) Computing
ĥ₄(σ,μ,λ)=(F₁h₄)(σ,μ,λ)
on a grid in the σ-μ plane,
(h) Computing
ĥ₅(σ,μ,λ)=i2πsign(σ)ĥ₄(σ,μ,λ)
on a grid in the σ-μ plane,
(i) Defining ĝ₅(ξ, η, λ) in the ξ-η plane by
ĝ₅(σ cos μ,σ sin μ,λ)=ĥ₅(σ,μ,λ),
(j) Computing
g₆(u,v,λ)=(F₂⁻¹ĝ₅)(u,v,λ).
on a grid in the u-v plane.

3. The method of claim 2, wherein nonuniform fast Fourier transforms are used for steps (b) and (j).

4. An image processing device for reconstructing a 3D image of an object's volume of interest from a set of cone-beam projections of this object, the cone-beam projections being taken along a plurality of source positions along a source trajectory around the object, the image processing device comprising:
a memory for storing a multi-dimensional dataset;
a calculation unit being adapted for:
filtering the set of projections on the basis of a concentric circles grid in Fourier space, resulting in a filtered projection data set; and
reconstructing the volume of interest from the filtered projection data set, resulting in a reconstructed image of the volume of interest.

5. An examination apparatus comprising:
an acquisition unit for acquiring a set of cone-beam projections of an object; and
an image processing device for reconstructing an image of the object's volume of interest, the reconstruction unit being adapted for:
filtering the set of projections on the basis of a concentric circles grid in Fourier space, resulting in a filtered projection data set; and
reconstructing the volume of interest from the filtered projection data set, resulting in a reconstructed image of the volume of interest.

6. The examination apparatus of claim 5, configured as one of the group consisting of a baggage inspection apparatus, a medical diagnostic apparatus, a material testing apparatus and a material science analysis apparatus.

7. A computer-readable medium, in which a computer program of reconstructing a 3D image of an object's volume of interest from a set of cone-beam projections of the object with an examination apparatus is stored which, when being executed by a processor (401), is adapted to carry out the steps of:
filtering the set of projections on the basis of a concentric circles grid in Fourier space, resulting in a filtered projection data set; and
reconstructing the volume of interest from the filtered projection data set, resulting in a reconstructed image of the volume of interest.

8. A program element for reconstructing a 3D image of an object's volume of interest from a set of cone-beam projections of the object, which, when being executed by a processor (401), is adapted to carry out the steps of:
filtering the set of projections on the basis of a concentric circles grid in Fourier space, resulting in a filtered projection data set; and
reconstructing the volume of interest from the filtered projection data set, resulting in a reconstructed image of the volume of interest.
